(19) United States
(12) Patent Application Publication
(10) Pub. No.: US 2013/0275252 A1
(43) Pub. Date: Oct. 17, 2013

(54) System and Method for Managing a Vacation Property Exchange Network

(71) Applicant: DEMEURE OPERATING COMPANY, LTD., Waterloo (CA)

(72) Inventors: Gregory David Martin, Kitchener (CA); Benjamin Charles Kirkham Morris, Kitchener (CA); Robert Barlow-Busch, Kitchener (CA); Peter John Schwartz, Cambridge (CA); James Joseph Murphy, Elora (CA)

(73) Assignee: Demeure Operating Company, Ltd., Waterloo (CA)

(21) Appl. No.: 13/864,158

(22) Filed: Apr. 16, 2013

Related U.S. Application Data
(60) Provisional application No. 61/625,422, filed on Apr. 17, 2012.

(51) Int. Cl. G06Q 30/06

(52) U.S. Cl. CPC G06Q 30/06
USPC 705/26.3; 705/26.4

(57) ABSTRACT

A system and method is disclosed that provides an exchange marketplace for the use of vacation properties and other assets such as airplanes, yachts, etc. An inventory of items available for purchase or auction, each representing a use of an asset, is maintained. Auction bids or offers to purchase items in the inventory may be made either by offering to pay cash or by offering in trade a new item also representing use of an asset. An equivalent cash value is determined for new items offered in trade, and the transaction allowed to proceed if the determined value of the new item offered equals or exceeds the price of current bid of the item sought. The system thus allows for maximum flexibility in renting and trading the use of vacation properties and other assets.

This application claims priority from Provisional Application No. 61/625,422, filed Apr. 17, 2012, which is incorporated herein by reference in its entirety.

### FIELD OF THE INVENTION

The present invention relates generally to vacation properties, and more particularly to the renting and exchanging of such properties.

### BACKGROUND OF THE INVENTION

In recent years, more people have come to want to spend their vacation time in something larger than a standard hotel room with a bed and a bathroom. This has created a large demand for, and thus growth in, non-hotel vacation properties.

One solution is the purchase of a vacation property, i.e., a house or condominium in a resort location. In such a case, the owner incurs the full cost of ownership, just as with a primary residence. Further, while the owner of course has use of the vacation property, ownership of a vacation property alone provides no ability to vacation anywhere else.

For this reason, an owner of a vacation property may wish to rent the property, at times when the owner is not using it, to other vacationers so as to cover the costs or provide income. This was traditionally often accomplished by having someone local to the property act as a rental agent, and typically take a commission, sometimes 30% or more of the rental price. People seeking to vacation in, for example, the Lake Tahoe, Calif., area would typically contact agents in that area to secure a vacation rental. Alternatively, owners of Lake Tahoe properties might have advertised in newspapers in an area from which people often visit Lake Tahoe, such as the San Francisco Bay Area.

The growth of the internet has made the advertising of such rentals easier, allowing owners and agents to post vacation rental listings that can be searched by anyone with online access. There are websites devoted to vacation rentals, and more general websites such as Craigslist with portions designated for vacation rentals. However, the owner, or an agent, must still deal with potential renters, reach an agreement, collect money, etc.

Another solution is to do a “home swap,” i.e., a barter transaction with another owner, trading the use of the owner's property (in this case either a home residence or a vacation property) for the use of someone else's property for some period of time. In this situation, an owner must find someone with a suitable property in the location where the owner wants to vacation who in turn wants to vacation in the owner's location and finds the owner's property to be suitable. Again, the internet has made this somewhat easier, but two such owners who may find each other's property acceptable must find each other and then may have to negotiate over terms, for example, whether one property is more valuable and thus some further compensation is warranted, whether the use of an automobile is included, etc.

Still another solution to desiring non-hotel vacation properties has been the development of timeshare properties, in which an owner purchases a share in a unit at a resort location. The typical timeshare is sold by the week, i.e., a purchaser gets a week per year at a specific property (the “home resort”) for the purchase price, which can vary widely based upon the desirability of the resort and the season in which the week may be used.

But timeshares have their own limitations. While some owners like to visit the home resort every year, others would like to be able to vacation in different places. This in turn has led to the creation of exchange companies such as Interval International and RCI®, which allow an owner to deposit a week at the owner's home resort into a pool and receive a week at another resort if another owner has deposited a desired week at the other resort, thus accomplishing a type of swap; the second owner may receive a week at yet a third resort from the pool, etc.

However, these systems use only a limited “value” system that requires the deposited week to be of a value that is roughly the same as or greater than the week received, so that there is no significant allowance for the fact that one owner's week may be considered more valuable than another owner's week at a different resort. The “extra” value is lost, or inures to the benefit of the exchange company.

Also, an available week may be claimed by the first owner depositing a week of equal or greater value, in spite of the fact that another owner might be willing to provide a more valuable week in exchange. Thus, an owner willing to trade a more valuable week may be unable to use that extra value to obtain a desired week.

Timeshare weeks can also be rented, but this is subject to the same problems as renting a fully-owned vacation property as described above.

It would be useful to have a vacation property exchange network that allows for both cash and barter transactions, or a combination of both, while allowing owners more control over how they rent or trade their properties, as well as making better use of the value of the various properties.

### SUMMARY OF THE INVENTION

A system and method is disclosed that provides a vacation property exchange marketplace that allows for maximum flexibility in renting and trading the use of vacation properties and other assets.

A first embodiment discloses a computer-implemented method of conducting an auction comprising: receiving, at a computing device, an offer of use of a first asset from a first owner for payment in cash; receiving, at the computing device, a first bid for the offer of use of the first asset containing an offer of payment in cash of a specified value; receiving, at the computing device, a second bid for the offer of use of the first asset containing an offer of use of a second asset; determining, by the computing device, an equivalent cash value of the second bid; determining, by the computing device, that the equivalent cash value of the second bid is greater than the specified value of the first bid; selecting, by the computing device, the second bid as the winning bid in the auction; and providing, by the computing device, instructions to pay the first owner an amount of cash equal to the equivalent cash value of the second bid.

In another embodiment a computer-implemented method is disclosed of allowing barter transactions for the use of assets comprising: establishing, by a computing device, an inventory comprising a plurality of offers, each offer being an offer of use of an asset in the plurality of assets in exchange for a specified amount of cash; receiving, at the computing device, a purchase offer for a first one of the plurality of offers in the inventory, the purchase offer containing an offer of a use of a second asset in the plurality of assets; determining, by the computing device, an equivalent cash value of the purchase offer determining, by the computing device, that the equivalent cash value of the purchase offer is equal to or greater than the specified amount of cash in the first one of the plurality of offers; providing, by the computing device, instructions to pay the specified amount of cash in the first one of the plurality of offers; and adding, by the computing device, the offer of the use of the second asset to the inventory.

Another embodiment discloses a system for managing a pool of offers for the use of a plurality of assets comprising: a memory for storing a database containing a plurality of offers, each offer being an offer from an owner of an asset in the plurality of assets of a use of the owner's asset in exchange for a specified amount of cash; an input for receiving a purchase offer for a first one of the plurality of offers, the purchase offer containing an offer of a use of a second asset in the plurality of assets; a processor configured to: determine an equivalent cash value of the purchase offer; compare the equivalent cash value of the purchase offer to the specified amount of cash in the first one of the plurality of offers; if the equivalent cash value of the purchase offer is equal to or greater than the specified amount of cash in the first offer, settle the transaction by providing instructions to pay the specified amount of cash for the first one of the plurality of offers, and update the database by: indicating that the first offer is no longer available; and adding the second offer to the database.

### BRIEF DESCRIPTION OF THE DRAWINGS

FIG. 1 is a block diagram of various modules that may be used in one embodiment of a system for managing a vacation property exchange marketplace.

FIG. 2 is a block diagram illustrating the flow of items through a system such as that shown in FIG. 1.

FIG. 3 is a block diagram illustrating further detail of the flow of items through a system such as that shown in FIG. 1 in a barter transaction.

FIG. 4 is a block diagram illustrating further detail of an asset index module of FIG. 1.

FIG. 5 is a graph of a seasonally adjusted usage or rental rate as may be used in one embodiment.

FIG. 6 is a diagram showing a representation of blackout dates and availability windows for the use of an asset.

FIG. 7 is a block diagram indicating how a marketplace system allows for the interaction of cash buyers, barter buyers, cash sellers, and barter sellers.

FIG. 8 is a block diagram of an auction module that handles auctions including both cash and barter bids.

FIG. 9 is an example of a graph showing the seasonal variations in the pricing of properties in a geographic region.

FIG. 10 is an example of a graph showing the seasonal variation in pricing of a specific property in the region shown in FIG. 9.

FIG. 11 is a graph showing a variety of possible curves of a lead time adjustment factor that may be used to value a barter offer.

FIG. 12 illustrates chains of asset contracts that may be used to help value a barter offer.

FIG. 13 is a flowchart of a method of conducting an auction for the use of an asset according to one embodiment.

FIG. 14 is a flowchart of a method of purchasing the use of an asset with a barter payment according to one embodiment.

### DETAILED DESCRIPTION OF THE INVENTION

Described herein is a vacation property exchange marketplace that provides for maximum flexibility in renting and trading the use of vacation properties and other assets. The marketplace is capable of handling cash and barter transactions, auction and non-auction transactions, and provides a number of possible adjustments to the value of property uses offered as barter based upon a variety of factors.

Vacations properties, i.e., real estate, are generally used herein as a typical example, but other assets may be handled by the described system and method as well, for example, airplanes, boats or yachts, and automobiles. One of skill in the art will appreciate yet other assets for which the present invention may be appropriate.

As used herein, an “owner” of an asset includes one who has the right to use the asset; for example, some properties are not sold in fee simple, but leased for a long period, perhaps 100 years. Similarly, one who has purchased a timeshare unit, and thus has a right of use to a timeshared property, is an owner as contemplated herein. Also as used herein, “cash” is deemed to include any form of commonly recognized currency transaction, including credit or debit card payments or charges, electronic transfers, checks, etc.

The marketplace allows someone to buy or sell the use of a property for a period of time for cash, or to trade such a use of a property that they own for a use of someone else's property. Each asset is identified; for example, in the case of real property, i.e., a house, condominium, or timeshare, the address may be given. For other assets, other identifying information may be provided, such as the N-number of an aircraft or the registration number of a boat or yacht.

Each use of an asset is an “item” for sale or trade, and is defined by an access contract. An access contract will typically specify the asset in question (by the address or other identification), and the parameters of use, such as the dates and any other relevant information or restrictions, for example, a maximum number of guests, whether pets or smoking are permitted, etc. An item may be traded for cash, or may be traded for barter value as explained further below.

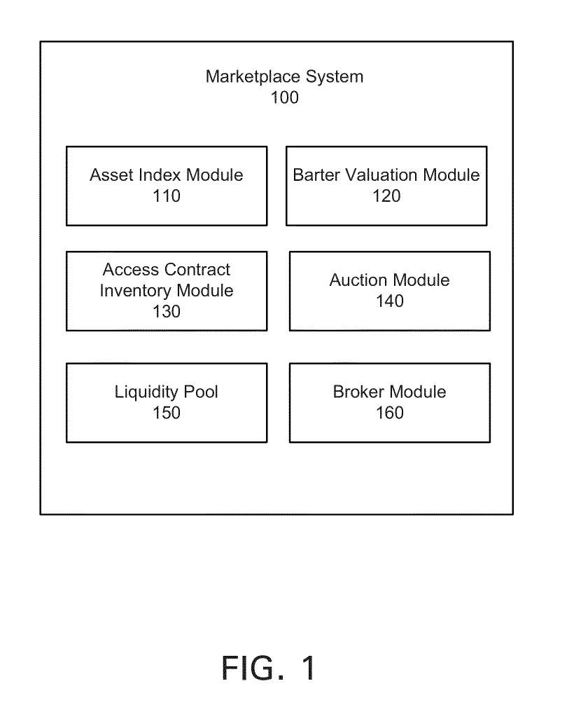

FIG. 1 is a block diagram showing various modules that may be used in one embodiment of a marketplace system 100 for managing such a vacation property exchange marketplace. Marketplace system 100 will typically be implemented in a computer system comprising one or more computers, processors or servers and associated input/output and storage devices, with access provided to buyers and sellers over a network, for example the internet, from the buyers' and sellers' own computing devices that may include computers, smartphones, tablets, and other devices. It is expected that the functions of the illustrated modules will be implemented in software within the computer system.

An asset index module 110 tracks and manages all of the assets for which access contracts are being traded in the marketplace, whether such access contracts are being traded for cash or barter value. Each asset has a set of valuation parameters, which, along with the parameters of a use in an access contract, are used to determine the value of an item, i.e., the use of the asset described in the access contract. When a new asset is added, some inspection of the asset is typically made, either by the system operator or an agent, perhaps one in the geographical area in which the property is located, to verify its existence and characteristics so that such valuation parameters may be determined and entered.

A value is determined for each barter item being traded so that barter items may be compared with cash items. A barter valuation module 120 determines a value for each item offered for barter, based upon the valuation parameters of the property, and the parameters of use of the asset in question as defined by the relevant asset access contract. This is explained in more detail below.

An access contract inventory module 130 tracks and manages the asset access contracts that are available for trade in the marketplace. An auction module 140 manages the bidding process when an access contract is made available by auction.

A liquidity pool module 150 tracks and manages a cash fund that is used to provide liquidity to the marketplace as explained more fully elsewhere herein. A broker module 160 provides a set of rules for settling transactions in the marketplace, and can also function as a decision support module that helps to determine if and how additional asset access contracts should be purchased to assist in maintaining liquidity and availability in the marketplace, and how to set reserve prices for access contracts.

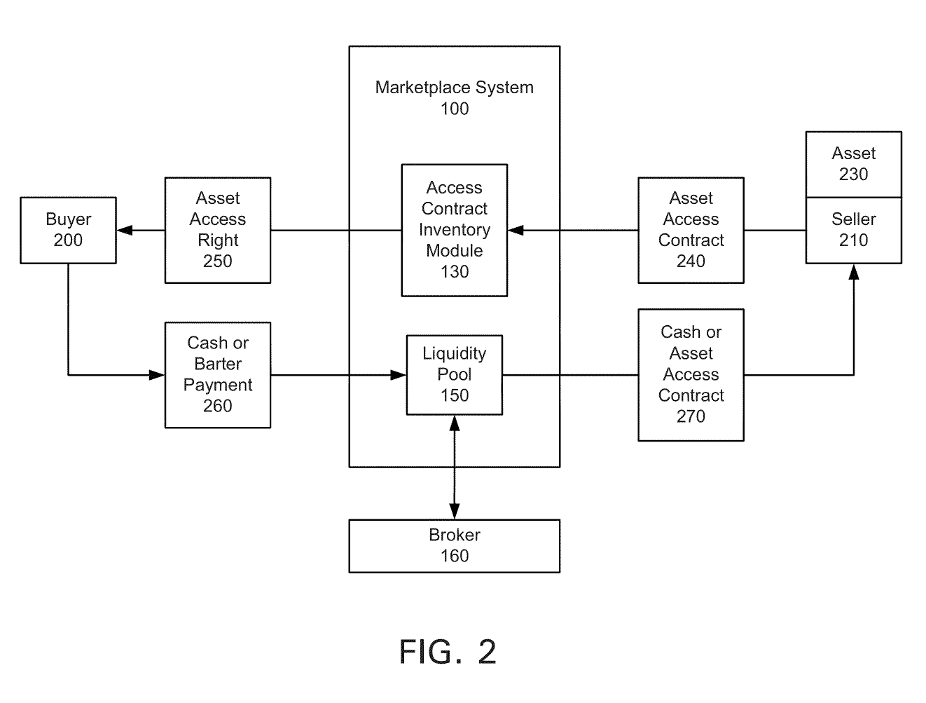

FIG. 2 depicts the general flow of items through the marketplace system 100 as managed by these modules for a buyer 200 and seller 210. A seller 210 is one who has a right to use an asset 230, for example, a property such as a house, condominium, or timeshare week. Seller 210 may be the owner of the asset, or an agent acting on behalf of the owner.

The seller 210 provides to the marketplace system 100 an item, i.e., some use of the property, by offering to sell an asset access contract 240 describing the use that is being offered. The availability of the asset is validated by removal of the periods for which the asset is already booked or otherwise not available, within a pre-determined maximum date range, for example 18 months from the present date. The asset access contract 240 is entered into and tracked by the access contract inventory module 130.

The buyer 200 is one who wishes to purchase an item, i.e., an asset access right 250 that corresponds to a property use defined by an access contract 240 offered by a seller 210. Once an item is purchased as discussed in further detail below, the buyer 200 provides payment 260 for the purchased asset access right 250 to the marketplace system. The marketplace system 100 then settles the transaction by transferring the asset access contract 240 to buyer 200 and forwarding the payment to the seller 210.

If buyer 200 purchases asset access right 250 by making payment 260 in cash, and seller 210 has requested cash, then the transaction is simple; cash is received in liquidity pool 150 from buyer 200, and then forwarded to seller 210 as payment 270. A buyer 200 may participate in the marketplace solely on such a cash basis, and need not own any asset in order to do so.

However, a feature of the marketplace system is that it is not limited to cash transactions, and, if buyer 200 does own an asset, allows for payment 260 to be made in another way, i.e., via a barter payment of use of that asset. In such a case, the payment 260 is represented by another asset access contract that is provided to the marketplace system 100. The barter valuation module 120 of marketplace system 100 determines a value for the barter payment 260 as will be further explained below, and if the value is sufficient the transaction proceeds.

In such a case, seller 210 may be given the option of receiving cash for the asset access contract 240 from marketplace system 100, or accepting the barter payment 260. If seller 210 desires a cash payment, the asset access contract for the property of buyer 200 becomes a new asset access contract 240 and is entered into the access contract inventory module 130, and payment to seller 210 is made in cash from the liquidity pool 150 to settle the transaction.

If, on the other hand, the seller 210 agrees to accept the barter payment 260 as payment for asset access contract 240, then the asset access contract for the property of buyer 200 is transferred to seller 210 as payment 270 to settle the transaction.

This ability to allow a buyer to choose between cash and barter for payment 260 provides flexibility for buyers, helps to create a larger inventory of asset access contracts 240 that attracts more buyers, and can contribute to liquidity in the system.

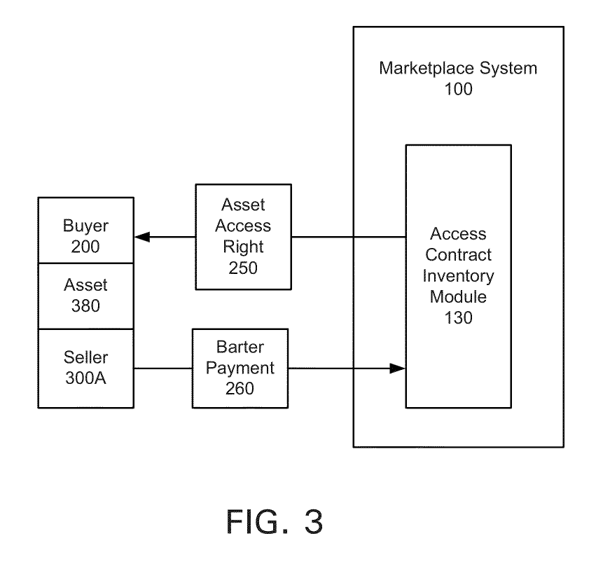

FIG. 3 provides a further explanation of the transaction flow in a case where the buyer wishes to make a barter payment 260. As above, assets are registered in the asset index module 110, each asset having a set of valuation parameters.

When a buyer 200 desires to make a barter payment 260, the buyer 200 also acts as a seller 300A, and chooses the parameters of use for the access contract for an asset 380 which he is willing to exchange as payment for the asset access right 250 that he desires to purchase. The barter valuation module 120 determines the value of the barter payment 260 based upon the valuation parameters of the asset 380 and the parameters of use specified by the buyer 200 (who again is also seller 300A).

For the transaction to be consummated, the value of barter payment 260 must be equal to or greater than the value of asset access contract 240. A further explanation of such a transaction is explained further below. In one embodiment, if the value of the asset access contract offered by buyer 200 for asset 308 is not equal to or greater than the value of the asset access contract 240, buyer 200 may increase the value of barter payment 260 by adding cash to the offer in an amount sufficient to make barter payment 260 equal to the value of the desired asset access contract 240.

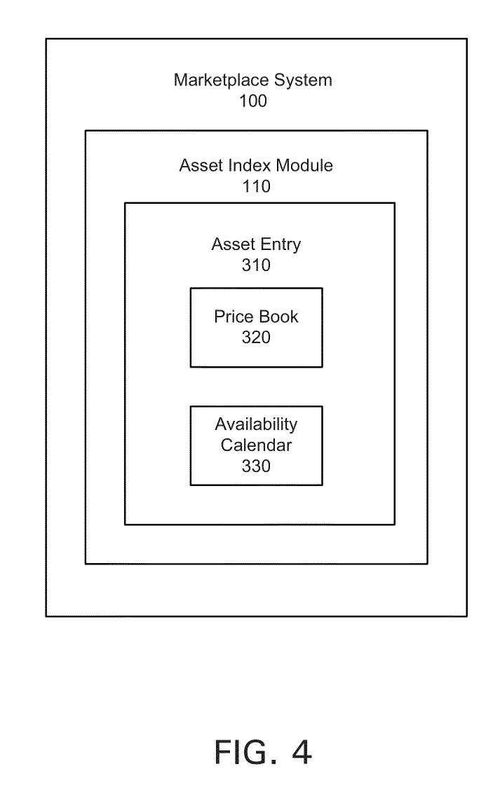

FIG. 4 shows additional detail regarding the asset index module 110. Each asset for which an asset access contract exists has an entry 410 in asset index module 110. As above, the asset is described in some fashion, such as address (real property) or registration number (boats and planes), along with any desired metadata describing the physical characteristics of the asset, for example, size, number of rooms, etc.

Each asset also has a price book 420, which lists a set of expected rental or usage rates for the asset. The rates will typically be on a per night or per single use basis, as appropriate for the asset, and may be determined based upon a number of factors, including location, size, condition, the “luxuriousness” of the asset, market rates for similar assets, and any other market factors, whether tangible or intangible, that are believed to affect how desirable an asset is for use rather than ownership. In some embodiments, the price book may be determined by the owner of the asset in question, while in other cases the price book may be determined by the system operator based upon, for example, market conditions and expected demand, and which may then reviewed by the owner. Of course, an owner need not permit use of an asset on terms unacceptable to the owner.

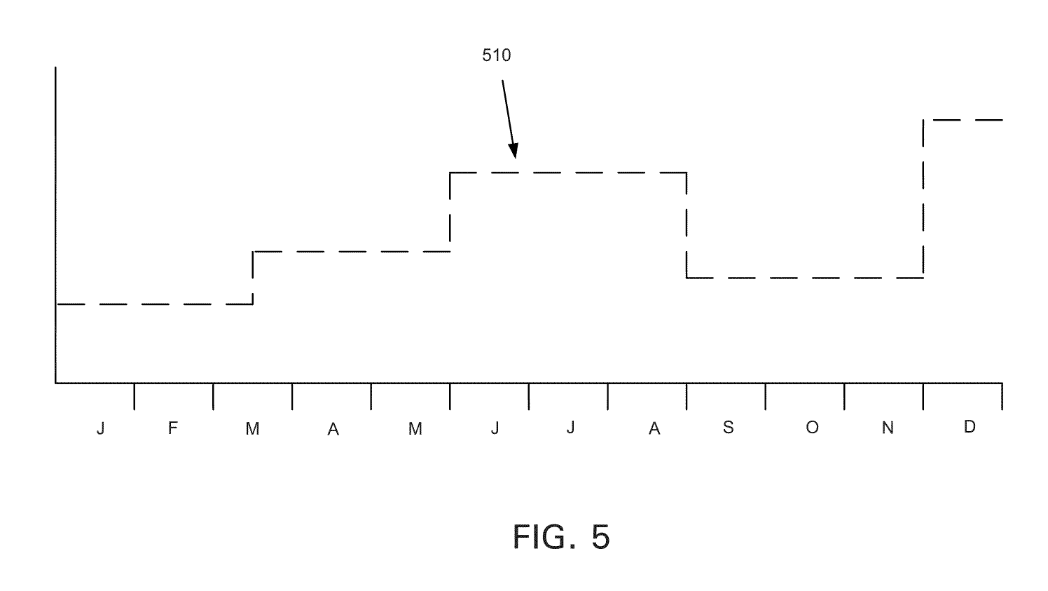

Rental or usage rates may also vary by the month or season. For example, FIG. 5 shows a seasonally adjusted usage rate for a property. The x-axis represents the months of the year, indicated by J (January), F (February), M (March), etc., through D (December), while the y-axis may, for example, be the price of use of the asset per use (or per day), or, as explained below, a dimensionless value representing the ratio of the price during each period with the maximum price of use of the asset. The graph 510 of the seasonally adjusted usage rate might, for example, represent a property located in a place where summer is considered the most desirable season and December is desirable for holiday vacations, while fall and winter are least desirable, perhaps due to weather. In some cases, usage rates could vary by day of the week, for example, if weekends are a more popular time to use a particular asset.

Referring again to FIG. 4, the price book 420 will preferably cover as much of the year as possible, although partial-year pricing is possible and should not be a problem as long as rates are provided for every asset use that is to be traded in the marketplace. The price books of different assets may have similar seasonal adjustments to rates for particular calendar periods that reflect the desirability of all assets in a geographic reason, the seasonal desirability of a particular type of asset (for example, for yachting season), or any other appropriate clustering or grouping, as determined by the owner and/or the system operator as above.

The price of an access contract for an asset will generally be the sum of the single use rate for each of the uses in question. Thus, for real property, the price of an access contract will be the sum of the rates for each night to be spent at the property. If the daily rates are uniform, this will be the daily rate times the number of days of use.

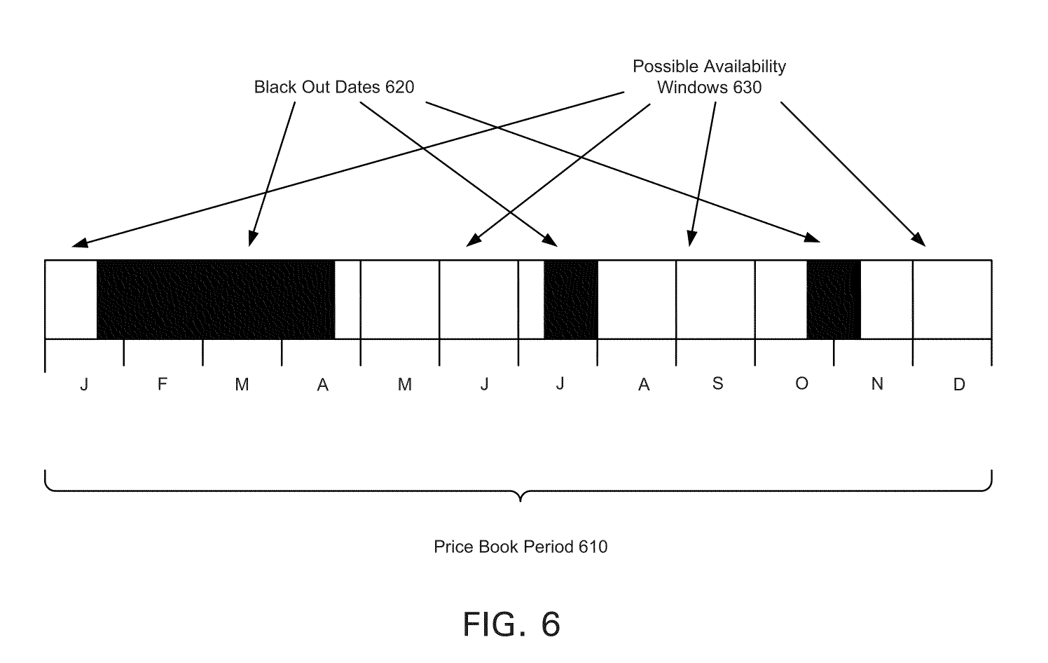

An asset in the asset index module 110 will also have an availability calendar 430, which shows the availability of the asset. FIG. 6 shows one representation of the availability of an asset over a year-long period 610. As in FIG. 5, the months of a year are represented by the first letter of each month, i.e., J for January, etc. Blackout dates 620 are identified to indicate those dates for which the asset is unavailable, for example, because the asset is to be used by the owner or because the owner chooses not to make the asset available for some other reason. Removing the blackout dates 620 from the period provided in the price book results in windows of possible availability 630, which are the times for which asset access contracts may be made available.

Referring again to FIG. 2, the access contract inventory module 130 tracks the inventory in the marketplace, i.e., the asset access contracts. As above, each asset access contract represents a use of an asset, and defines an economic agreement governing the price and terms of such a use. The parameters of an asset access contract may typically include an identification of the asset by reference in the asset index module 110, the availability calendar 330 for the asset indicating the period during which the asset access contract may be exercised, and the number of nights or uses for which access is to be provided.

The asset access contract may optionally include other parameters. For example, if the asset access contract is to be put up for auction in marketplace system 100, a minimum or reserve price may be set by the seller as the lowest price the seller will accept to complete a transaction. In addition, the marketplace system 100 may provide for segmentation of buyers into groups. For example, if the marketplace system 100 has different levels of membership, the asset access contract may indicate that only members at or above a certain level may be buyers. Other possible groups may be based upon ownership of assets, as distinct from those who only pay cash, or previous performance in the marketplace system 100.

As above, there are two types of asset access contracts, rental asset contracts and barter asset contracts. Rental asset contracts are provided by owners who wish to make their assets available in the marketplace for cash payment. Typically, owners providing rental asset contracts will maintain full control over the parameters of the contract, setting the price (or minimum price for an auction), length or number of uses, availability of use, etc. Barter access contracts, by contrast, make assets available for uses for which the owners do not wish cash payment, but for which they are willing to accept the use of someone else's asset; in some embodiments, such owners are expected to give up control of at least some of the parameters of the contract, such as price or minimum price.

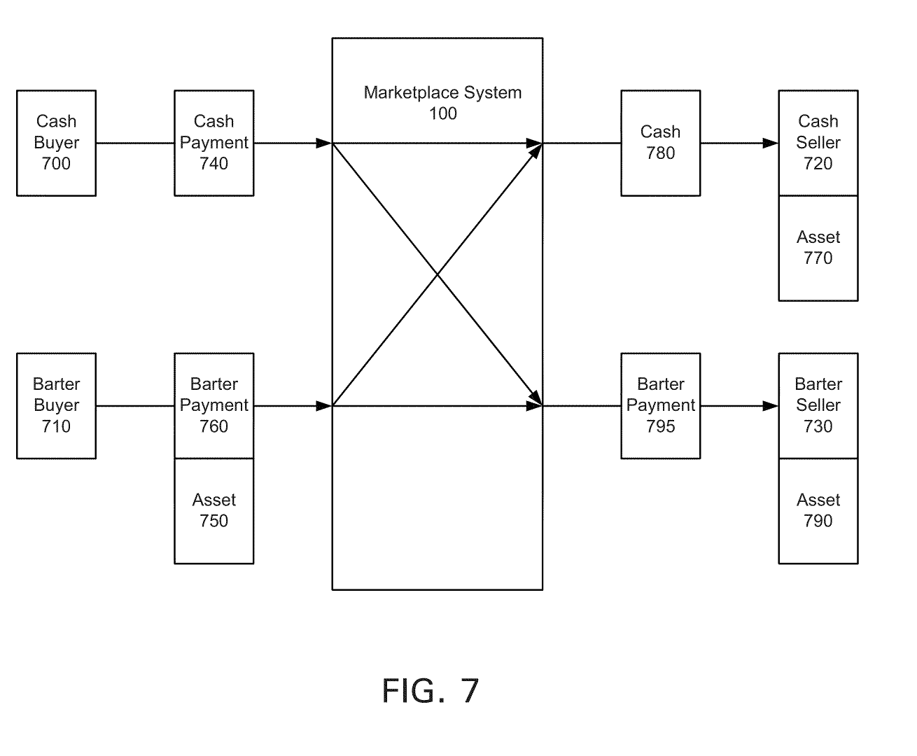

FIG. 7 is a block diagram indicating how a marketplace system allows for the interaction of a cash buyer 700, barter buyer 710, cash seller 720, and barter seller 730.

A cash buyer 700 may make a cash payment 7410 to marketplace system 100 to purchase an asset access contract; cash payment 740 goes into the liquidity pool 150, and or may not be paid to the seller of the asset access contract depending upon whether the seller of the asset access contract is a cash seller 720 or a barter seller 730.

A barter buyer 710 owns an asset 750, and uses an asset access contract for the use of asset 750 to make a barter payment 760. The asset access contract for asset 750 is valued by the barter valuation module 120, and then goes into the inventory of the marketplace system 100. The barter buyer 710 will be treated by marketplace system 100 as if he has made a barter payment 760 in cash in the amount at which the asset access contract for asset 750 is valued by the barter valuation module 120 as explained further below. As above, in some embodiments a cash payment may be added to make the amount of barter payment 760 sufficient to purchase a desired asset access contract.

A cash seller 720 provides an asset access contract for use of his asset 770 to marketplace system 100, and receives a cash payment 780 for the asset access contract from marketplace system 100, in either the amount he has set as the sales price, or, in the event the asset access contract is auctioned, the amount of the winning bid.

A barter seller 730 provides an asset access contract on his asset 790 to marketplace system 100, and receives back a barter payment 795 from marketplace system 100. In some cases, barter payment 795 may be received immediately in the form of an asset access contract for the use of another property; for example, as above, if buyer 710 has tendered an asset access contract on asset 750 as barter payment 760 in order to buy the asset access contract on asset 790, barter seller 730 may choose to accept the asset access contract on asset 750 as barter payment 795. In other cases, barter seller 730 may accept a credit for the value of the asset access contract on asset 790; the credit may be used as a cash equivalent to purchase an asset access contract on another asset at a later date.

It will be seen that barter buyer 710 is really both a barter buyer and a barter seller, as is barter seller 730, since they both provide an asset access contract for the use of their asset in exchange for an asset access contract on another's asset.

The settlement of these transactions is performed by the marketplace system 100. A cash buyer 700 purchasing an asset access contract from a cash seller 720 simply requires a straight pass-through of the cash payment. A barter payment 760 from a barter buyer 710 for an asset access contract from a barter seller 730 is settled by offsetting entries in the access contract inventory module 130; the asset access contract that is barter payment 760 is entered in inventory, and the asset access contract that has been purchased is removed from inventory. Such a transaction requires no cash to settle.

Transactions in which a cash buyer 700 buys from a barter seller 730 or a barter buyer 710 buys from a cash seller 720 are facilitated by the liquidity pool 150, which as above is a cash fund. When a cash payment 740 is received for an asset access contract from a barter seller 730, it is added to the liquidity pool 150 since the barter seller 730 does not receive cash, while the purchased asset access contract is removed from inventory. Conversely, when a barter payment 760 is received for an asset access contract from a cash seller 720, cash must be paid out from liquidity pool 150, while the received asset access contract is added to inventory.

The marketplace system 100 is able to accommodate such barter-for-cash transactions as long as there is a sufficient balance in liquidity pool 150. If the balance in liquidity pool 150 falls below a certain level, as determined by the operator of marketplace system 100 based on, for example, the actual or expected amount of activity requiring cash to be paid out, it may not be possible to sell asset access contracts from cash sellers 720 to barter buyers 710 until additional cash is received. Such barter-for-cash transactions may thus have to be suspended in the interim, or, alternatively, additional cash may be secured, for example, by borrowing or by providing some inducement for buyers to pay in cash. Of course, if there are only cash-for-barter transactions, liquidity pool 150 will grow while inventory will shrink, and so a balance of transactions is desirable.

To provide additional control over barter payments and increase inventory levels so as to draw more buyers into the marketplace, incentives may be provided for asset owners who are willing to be barter sellers 730 “in advance,” i.e., to accept credit for their asset access contracts to be used later as above rather than immediate payment either in cash or in the form of another asset access contract.

As above, such a credit is treated as a cash equivalent, and thus a barter seller 730 holding a credit in effect is now treated as a cash buyer 700. However, one possible way to provide an additional inducement is to permit a barter seller 730 who holds a credit to “shortcut” an auction and immediately book an asset access contract that is being auctioned if the amount of the credit exceeds the minimum or reserve price on the auction.

Another possible inducement is to provide a barter seller 730 who sells an asset access contract in advance with some control over the minimum price of the asset access contract, while requiring a barter buyer 710 to waive such control. Other inducements are possible as well.

As above, a barter seller 730 who sells an asset access contract in advance has no expectation of a cash payment, or of receiving an asset access contract in return immediately. In this case, the asset access contract on property 790 goes into the inventory of the marketplace system 100 and is recorded in the access contract inventory module 130.

It is desirable that the marketplace system 100 be able to handle auctions of asset access contracts as well as fixed-price listings. Auction module 140 in marketplace system 100 provides for the acceptance of competitive bids in the form of either cash or barter. In order for this to occur, an asset access contract submitted as a bid in an auction is again given a value by barter valuation module 120.

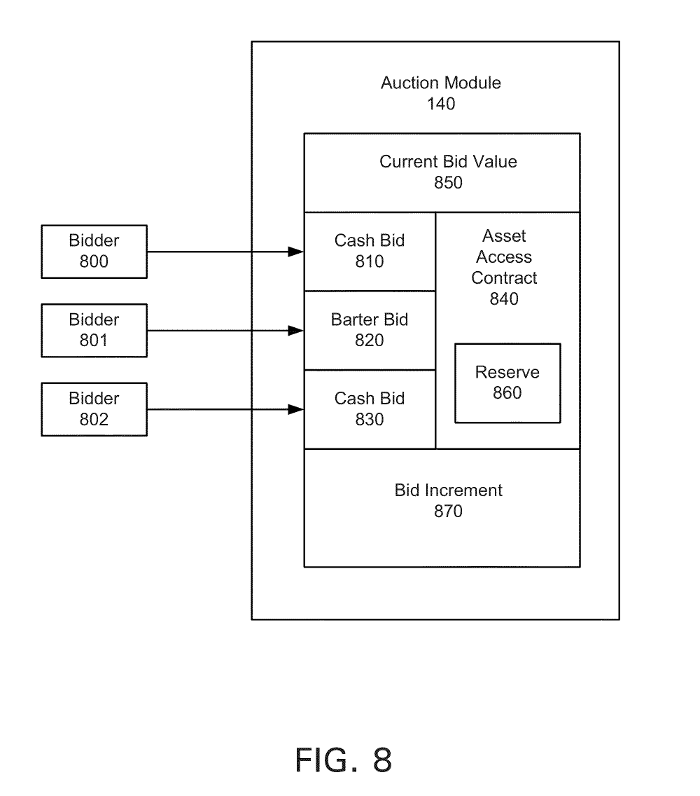

FIG. 8 shows one embodiment of the operation of auction module 140. Here an asset access contract 840 is up for auction. A reserve price 860 may be selected as the minimum acceptable winning bid, or as the initial bid that will be allowed to be entered. If the owner has put the asset access contract 840 up for auction, then the owner will typically set the reserve price 860; if the asset access contract 840 is one that was received as a barter payment, then the system operator may set the reserve price 860. A minimum bid increment 870 may be set as the amount by which a new bid must exceed the current bid value 850 in order for the new bid to be entered and become the new current bid value; this will typically be set by the system operator to facilitate a reasonable bidding process by avoiding bids that increment by only very small amounts.

Here bidders 800 and 802 have submitted cash bids 810 and 830 respectively, while bidder 801 has submitted a barter bid 820. Once barter bid 820 has been given a value by barter valuation module 120, that value is directly compared to cash bids 810 and 830. In some embodiments, all cash bids may be separately entered by each bidder, and a barter bid deemed to be for the amount of the asset access contract submitted as determined by barter valuation module 120.

In other embodiments, bidders 800 and/or 802 may allow auction module 140 to automatically enter subsequent bids on their behalf, each bid being a bid increment 870 above the current bid value 850, up to a maximum bid value specified by the respective bidder that is not to be exceeded. In the case of bidder 801, auction module 140 may initially set a bid at the bid increment 870 over the current bid value, and then automatically increase the bid value when necessary, again up to the value of the asset access contract submitted by bidder 801 as the bid.

As each bid is made, auction module 140 selects the bid with the then-highest value as the current bid value 850; at the end of the auction, the then-highest bid will be the current bid value 850, and will be selected as the winning bid. Appendix 1 is a listing of pseudo-code for an example of an algorithm that may be used to determine the current bid value 850.

As above, in a number of situations an asset access contract may be submitted by an owner. The barter valuation module 120 establishes a cash valuation for each asset access contract that is submitted as a proposed barter payment or offer. This cash valuation may be used to compare the barter payment or offer with cash bids in the case of an auction, or to determine whether the barter payment is sufficient to purchase an asset access contract from a cash seller.

In one embodiment, the barter value V_{barter} of an asset contract is calculated by barter valuation module 120 as:

V_{barter}=V_{usage}*α

where V_{usage} is the expected value that the asset access contract would have if it were sold immediately, and α is a discount factor that accounts for the risk taken of being able to sell the asset access contract once it is placed in inventory.

The expected value V_{usage} of an asset access contract sold immediately is calculated as:

V_{usage}=P*k_{average}*δ*η*γ*φ

where:

P is a usage potential ratio;

k_{average} is a dimensionless average daily value for a single use of the asset k;

δ is a value multiplier that maps k into an absolute value;

η is a capacity step down factor as explained below;

γ is a privacy adjustment factor as explained below; and

φ is a lead time adjustment factor as explained below.

The usage potential ratio P compares the amount of usage that has been provided for an asset out of the total available usage of that asset, taking variations of usage rates into account. Thus, in the case of real property, P is the sum of the usage rates for the dates of the asset access contract, divided by the usage rates for all dates for which the property is available, i.e.:

$$P = \frac{Σ {k}_{provided}}{Σ {k}_{available}}$$

The k values are dimensionless values ranging from 0 to 1, representing the value of the asset over the availability calendar, so that at times during which the asset is of the highest value k is 1. At times other than that of highest value, the value of the asset is scaled to a value between 0 and 1, thus representing the relative value of the asset at those times. For example, in the chart of FIG. 5, the value of the property in question in December is 1, and in spring (mid-March to May) and fall (September to November) might be 0.5, indicating that the property is only half as valuable during those times.

The k values for a specific asset may be derived from pricing specific to the asset, and from other factors as well. For example, in the case of real property, while the property itself is considered, the k values are also likely to take into account the geographical area in which the property is located and seasonal pricing curves indicating what average k values are for the region.

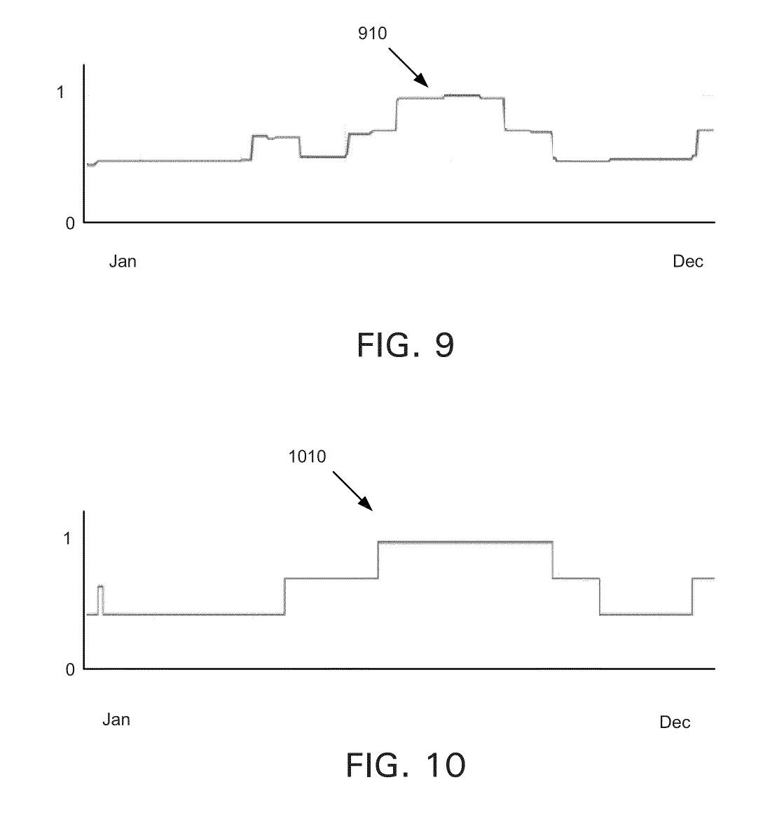

For example, FIG. 9 shows an example of an aggregate seasonal pricing curve showing average k values for a particular geographic region over a year period. As with an individual property, the k value for the region is set by the system at 1 at the time when property use is at its greatest value, and other times is scaled between 0 and 1 according to the relative value of properties compared to the peak value based upon aggregate seasonal market prices. The k values over the course of a year form curve 910.

The characteristics of a specific property are then taken into account along with the aggregate curve of FIG. 9. In one case, this might result in the k values shown in the property-specific pricing curve of FIG. 10. Again, the time of peak value is set by the system to have a k value of 1, and other times are scaled by the relative value compared to the peak; this scaling will generally be done by the system operator, but in some instances may be done by, or in consultation with, the owner of the asset. While the curve 1010 of FIG. 10 for a specific property is likely to have a similar overall shape to the curve of FIG. 9 for the region, as shown here there may be variations in the k values for a specific property from the average k values of all properties that reflect the particular desirability of the specific property.

The average daily value k_{average} is the average of k_{provided} over the contract period, calculated as the sum of the k values for the dates of the asset access contract, i.e., Σk_{provided}, divided by the number of days in the contract period. This allows for contracts during which the k values change; however, where the daily k value is the same over the contract period, k_{average} will simply be the daily k value.

The value multiplier δ is a number that turns a daily k value into an absolute dollar value. Thus, if a property's peak value is deemed to be $500 per day, δ will be $500, so that the use of the property will be valued at $500 at the time of its highest value, and less at times when the k value is smaller.

The capacity step down factor η is used to discount multiple offers of additional use of a property. This is due to the fact that the marketplace is believed to favor diversity in assets, i.e., it is generally more valuable to have one week available at each of 10 properties (and easier to sell) than to have 10 weeks available at the same property. Thus, the first available use of a property is considered the most valuable, and additional uses are considered to have a decreasing marginal value.

For example, the first week offered in a particular property might be valued at a particular rate, and each additional week at 25% less of the original value than the prior week. This would result in the following valuation:

| Usage offered | Marginal value | Total value |
|---|---|---|
| 1 week | 100% | 100% of 1^{st} week |
| 2 weeks | 75% | 175% of 1^{st} week |
| 3 weeks | 50% | 225% of 1^{st} week |
| 4 weeks | 25% | 250% of 1^{st} week |
| Additional | 0 | 250% of 1^{st} week |

This step-down factor would thus reduce the value of a daily k value after the first week, and thus the value of k_{average} for an availability period of more than a week. Of course, the marginal value may decrease by some amount less than 25% per week; for example, in an area considered to be of sufficiently higher demand, each additional week might decrease by 10% or some other amount.

As above, an owner offering a barter contract may wish to specify in the asset access contract parameters of use which in turn determine which class(es) of participants in marketplace system 100 may be permitted to purchase the contract. For example, as above an asset access contract may specify marketplace members of a particular level or above, those who have a history of purchasing asset access contracts with no reported issues as a result of using the asset, only members who own property, etc. The privacy adjustment factor γ is used by the system operator to adjust the value of an offer based upon the anticipated portion of the marketplace to which the asset access contract will be made available for purchase.

If the access contract is available to the entire marketplace, there should be no reduction in the contract's value. However, the smaller the portion of the marketplace to which the contract is available (i.e., the more “private” the offering is), the less valuable the contract is considered to be, as it will be harder to sell.

If desired, various segments of the participants of marketplace system 100 may be defined with a privacy adjustment factor γ specified for each segment. For example, γ may be set to 100% if all members are allowed to purchase the asset access contract, 75% if purchase is limited to a more exclusive level of membership, or 50% if only top-tier members are allowed to purchase the asset access contract.

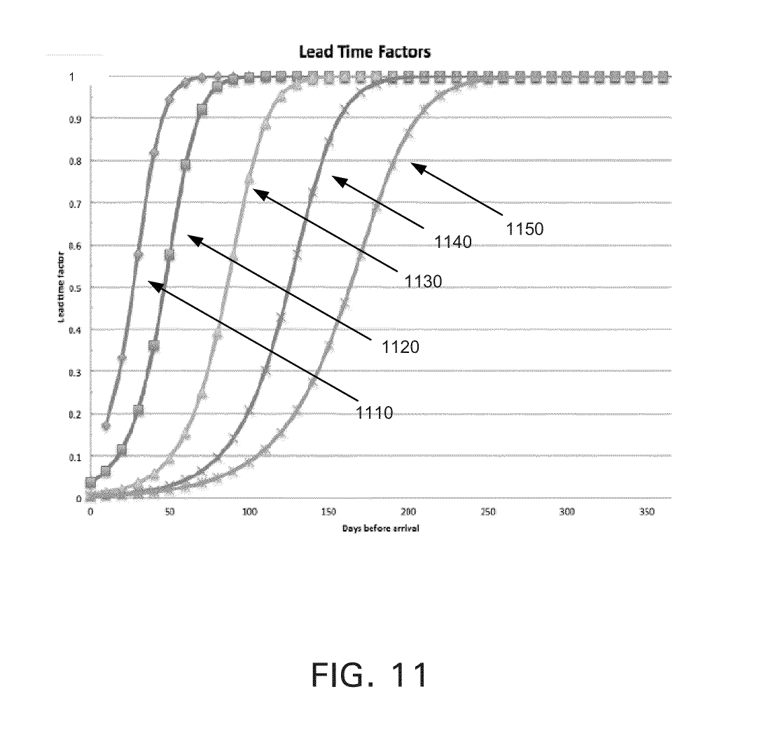

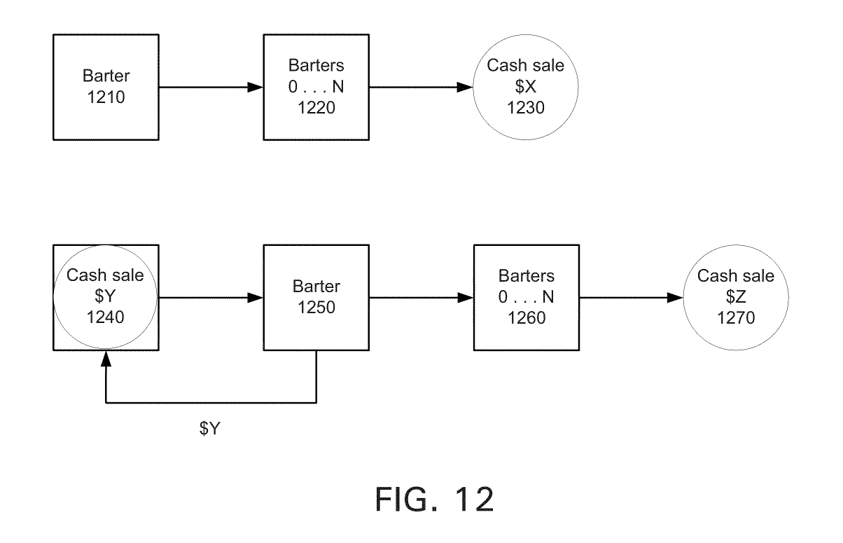

The lead time adjustment factor φ is another value from that is used by the system operator to adjust for the time between when the offer of an asset access contract is made, and the time when the use specified in the asset access contract is to be available. FIG. 11 shows several possible curves 1110 to 1150 of the lead time adjustment factor φ that might be used in appropriate instances.

A contract for use of an asset which is to occur immediately is less likely to be sold than one which will occur farther in the future, allowing time for more of the buyers in the marketplace to become aware of and purchase the contract. Thus, an asset contract offered far enough in advance should be valued at its maximum (given the other parameters above), while one offered on short notice will be discounted. This provides an incentive for barter offers to be made well in advance.

How much discount should be applied for a particular lead time may vary widely based upon the particular asset involved. Thus, for example, an asset access contract for a ski chalet in a desirable ski location in the middle of winter may be considered to be easy to sell on short notice, and the lead time adjustment curve 1110 applied to the asset access contract, indicating that even with about 30 days of notice it is likely that a transaction can be consummated with the asset access contract. On the other hand, an asset access contract in a less desirable location offered in the off-season may be given one of the other lead time adjustment curves 1120 to 1150 based upon the assessment of the system operator of how difficult it will be to consummate a transaction with the asset access contract in the time before the use is to take place. It is expected that the lead time adjustment curve applied to a particular asset access contract will be largely based on historical data of sales of asset access contracts for similar properties in the same or similar locations.

As stated above, the broker module can perform several functions, including governing the various transactions allowed in the marketplace system 100. Another possible function of the broker module 160 is to set reserve prices for asset access contracts provided by barter sellers. One way in which this may be done is by considering the aggregate performance of the market, as measured by the liquidity pool 150.

In one embodiment, the broker module 160 uses a “chain” of asset access contracts to determine marketplace performance. A chain of asset access contracts is a list of related barter transactions that stem from a first barter asset access contract, and terminate in a cash transaction. The cash transaction terminates the chain since it does not contribute another barter asset access contract to the inventory.

The broker module may consider two types of chains. First, a chain may originate with a barter asset access contract provided in advance as described above for which the owner does not receive cash, but rather receives a credit to be used later to purchase another asset access contract, effectively trading one asset access contract for another.

For example, in FIG. 12, a first chain starts with a barter asset access contract being offered in transaction 1210. This leads to a chain of N barter transactions 1220, in each of which one asset access contract is removed from inventory, and one asset access contract is added to inventory. Finally, a cash buyer purchases an asset access contract at the end of the chain in transaction 1230 for $X in cash. The “cost basis” of this chain is considered to be the $X paid by the cash buyer for the last asset access contract in the chain.

A second chain starts with the offer in transaction 1240 of an asset access contract for which the owner requests cash. When this asset access contract is purchased by a buyer who pays with a barter payment of an asset access contract in transaction 1250, settlement of transaction 1250 requires that the broker module 160 direct payment of $Y in cash from liquidity pool 150 to the owner providing the asset access contract in transaction 1240. This chain then also leads to a sequence of N barter transactions 1260, again in each of which one asset access contract is added to inventory and one removed from inventory. Finally, a cash buyer pays $Z to purchase an asset access contract in transaction 1270. The cost basis of this chain is considered to be $Z-$Y, i.e., the cash received for the last transaction minus the cash paid for the first transaction.

The broker module 160 may maintain the cost basis of each chain as it is in progress, and compute the final cost basis when the chain is terminated by a cash purchase. The cost bases of all chains, whether terminated or not, may be used by broker module 160, along with consideration of the liquidity pool balance, to determine the reserve prices of asset access contracts that are currently active at auction.

As above, barter payments that are accepted will be of a value greater than or equal to the asset access contracts for which the barter payments are exchanged. Thus, for a given level of the liquidity pool, the value of the inventory will generally grow over time. However, as above, the value of the liquidity pool also fluctuates depending upon the number of cash buyers compared to the number of cash sellers, and the size of the cash transactions.

When the liquidity pool has a high balance relative to the number of transactions to be processed, reserve prices may be lowered so that some of the increased value of the inventory may be returned to the members of the marketplace system. On the other hand, when the liquidity pool has a relatively low balance, reserve prices may be set higher so as to bring more cash into the liquidity pool. The desirability of such decisions will be apparent to one of skill in the art.

In some embodiments, an owner may permit a “direct offer” of either cash or barter payment to be made at any time for the use of an asset of the owner that is already in the marketplace and registered in the asset index module 110, but for which the owner has not currently offered an asset access contract. The cash or barter offer may be constructed just as if there was an asset access contract for the asset, except that some or all of the constraints that the owner might place on the asset access contract may not be present.

When such a direct offer occurs, a proposed asset access contract is prepared by the broker module. In the case of a cash offer, the barter valuation module will value the requested asset access contract as above, and the buyer may offer that amount in cash; the owner may then accept or reject the offer. In the case of a barter offer, the owner may be offered the asset access contract offered by the buyer, and again the owner may accept or reject the offer. Negotiation and counter-offers may be permitted.

Alternatively, if the owner has indicated a desire for cash payment and the buyer wished to make a barter offer, the value of the offered asset access contract may be determined by the barter valuation module 120 as described above, and, if the value of the offered asset access contract exceeds the determined value of the requested asset access contract, the owner will be offered the value of the requested asset access contract in cash. In this case, payment will be made from the liquidity pool, and the asset access contract of the offered barter payment will be entered into inventory.

It will be remembered that in some of the barter transactions described herein, the asset access contract offered as payment will have a value greater than that of the asset access contract being purchased. As more such transactions occur, the inventory will increase in value as compared to its cost basis.

This increase in inventory value may be reversed by auctioning off some of the asset access contracts received for less than the value assigned to those contracts by the barter valuation module 120, in essence providing at least some members of the marketplace with discounted vacations. Such discounts may have the effect of increasing membership, thus leading to still more barter asset access contracts, and thus even more discounts. In this way, the very activity of the marketplace helps to sustain and grow the marketplace and maintain or increase the balance in the liquidity pool 150.

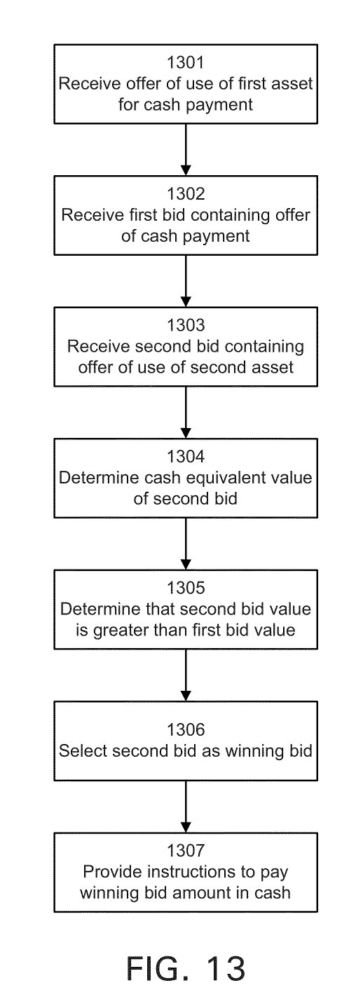

One embodiment of a method of conducting an auction for the use of a property that implements some of the elements described herein is shown in FIG. 13. At step 1301, a computing system, such as marketplace system 100 described above, receives an item for auction for cash payment, the item being an offer of use of a first asset. The computing system receives a first bid for the item containing an offer of cash payment at step 1302.

At step 1303, the computing system receives a second bid which contains an offer of use of a second asset rather than a cash payment, i.e., a barter bid as discussed above. The computing system applies a set of rules, such as those discussed above, to determine a cash equivalent value of the second bid at step 1304.

At step 1305, the computing system determines that the cash equivalent value of the second bid is greater than the cash value of the first bid, and selects the second bid as the winning bid at step 1306. At step 1307, the computing system then provides instructions to an appropriate source of funds, such as a bank holding an account that comprises a liquidity pool 150 as described above, to pay the owner of the first asset an amount of cash equal to the cash equivalent value of the second bid. The offer of use contained in the second bid is then available for a new auction or sale by the computing system.

While not illustrated, it should be apparent that if the value of the first bid is greater, then the computing system will select the first bid as the winning bid, receive cash from the buyer submitting the first bid, perhaps in the bank account containing liquidity pool 150, and transfer such cash to the owner of the first asset.

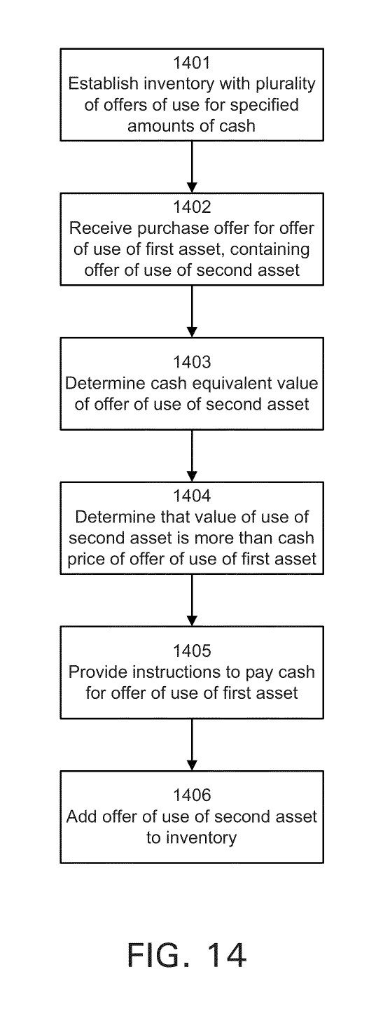

An embodiment of a method of allowing a barter payment that implements some of the elements described herein is shown in FIG. 14. At step 1401, an inventory is established at a computing system such as marketplace system 100 described herein, containing a plurality of offers, each offer being an offer of use for one of a plurality of assets, in exchange for cash payment.

At step 1402, the computing system receives a purchase offer for an offer of use of a first asset of the plurality of assets, the purchase offer containing an offer of use of a second asset rather than an offer of cash payment. At step 1403, the computing system determines the cash equivalent value of the offer of use of the second asset, i.e., the purchase offer, and at step 1404 determines that the determined cash equivalent value is more than the cash payment specified in the offer of use of the first asset.

At step 1404, the computing system then provides instructions to a source of funds, as above possibly a bank account comprising a liquidity pool 150, to pay the owner of the first asset the specified amount of cash in the offer of use of the first asset, and, at step 1406, adds the offer of use of the second asset to the inventory.

It will be apparent that if the cash equivalent value of the purchase offer, i.e., the offer of use of the second asset, is less than the amount of cash specified in the offer of use of the first asset, then the purchase offer will be rejected or ignored, and the transaction will not be consummated. As above, in some embodiments the purchase offer may be a combination of the offer of use of the second asset and cash; the amount of cash is simply added to the determined cash equivalent value of the use of the second asset to determine the value of the purchase offer.

One of skill in the art will appreciate that the illustrated methods and elements may be used to manage a large number of transactions for any desired number of assets, allowing both cash and barter transactions in fixed-price transactions as well as auctions, assuming adequate computing resources, a sufficiently large liquidity pool 150, etc.

The disclosed system and method has been explained above with reference to several embodiments. Other embodiments will be apparent to those skilled in the art in light of this disclosure. Certain aspects of the described method and apparatus may readily be implemented using configurations or steps other than those described in the embodiments above, or in conjunction with elements other than or in addition to those described above.

For example, as discussed above, the use of assets other than vacation properties may be rented and traded using the system and method described herein, such as airplanes, boats and yachts, and automobiles.

It should also be appreciated that the described method and apparatus can be implemented in numerous ways, including as a process, an apparatus, or a system. In particular, as above, such a method and apparatus may be implemented in a computing system comprising one or more computers, processors or servers, with associated input/output devices and storage devices, accessible to members of the marketplace system over a network from the members' own computing devices.

The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc. The methods may also be incorporated into hard-wired logic if desired. It should be noted that the order of the steps of the methods described herein may be altered and still be within the scope of the disclosure.

These and other variations upon the embodiments are intended to be covered by the present disclosure, which is limited only by the appended claims.

APPENDIX 1
Pseudocode listing--current bid value algorithm example:

```
bids = sorted list of cash and barter bids by value then submission time
return 0 if no bids
if highest bid is a cash bid?
    Other bids = remove bids if{bidder is same as first bid user}
    bids = [first bid] + other bids
    bids = remove from bids if{bid is cash bid and bid value < reserve }
    if bids length is 1
        return reserve value
    if second highest offer is a barter offer
        return highest offer value
    if second highest offer value == highest offer value
        return highest offer value
    return second highest bid value + BID_INCREMENT
else, highest bid is a barter bid
    cash bids = remove from bids if {barter offer}
    if highest cash bid
        return highest cash bid value + BID_INCREMENT
    else
        return reserve value
BID_INCREMENT is the minimum allowed difference in value between bids.
```

What is claimed is:

1. A computer-implemented method of conducting an auction comprising:
receiving, at a computing device, an offer of use of a first asset from a first owner for payment in cash;
receiving, at the computing device, a first bid for the offer of use of the first asset containing an offer of payment in cash of a specified value;
receiving, at the computing device, a second bid for the offer of use of the first asset containing an offer of use of a second asset;
determining, by the computing device, an equivalent cash value of the second bid;
determining, by the computing device, that the equivalent cash value of the second bid is greater than the specified value of the first bid;
selecting, by the computing device, the second bid as the winning bid in the auction; and
providing, by the computing device, instructions to pay the first owner an amount of cash equal to the equivalent cash value of the second bid.

2. The method of claim 1, further comprising:
making, by the computing device, the offer of use of the second asset available for a second auction;
receiving, at the computing device, a third bid for the offer of use of the second asset containing an offer of payment in cash of a specified value;
receiving, at the computing device, a fourth bid for the offer of use of the second asset containing an offer of use of a third asset;
determining, by the computing device, an equivalent cash value of the fourth bid;
determining, by the computing device, that the determined value of the fourth bid is greater than the value of the third bid; and
selecting, by the computing device, the fourth bid as the winning bid in the auction.

3. The method of claim 2, wherein a minimum bid for the second asset is set at an amount greater than the amount of cash for which instructions were given to pay the first owner.

4. The method of claim 3, wherein the minimum bid for the second asset is set at an amount less than the amount at which the use of the second asset is valued.

5. The method of claim 1, wherein the offer of use of the first asset is for a first period of time and the offer of use of the second asset is for a second period of time.

6. The method of claim 5 wherein one of the first property and the second property is a house, condominium, apartment or timeshare unit.

7. The method of claim 5 wherein one of the first property and the second property is a boat or yacht.

8. The method of claim 5 wherein one of the first property and the second property is an airplane.

9. A computer-implemented method of allowing barter transactions for the use of a plurality of assets comprising:
establishing, by a computing device, an inventory comprising a plurality of offers, each offer being an offer of use of an asset in the plurality of assets in exchange for a specified amount of cash;
receiving, at the computing device, a purchase offer for a first one of the plurality of offers in the inventory, the purchase offer containing an offer of a use of a second asset in the plurality of assets;
determining, by the computing device, an equivalent cash value of the purchase offer
determining, by the computing device, that the equivalent cash value of the purchase offer is equal to or greater than the specified amount of cash in the first one of the plurality of offers;
providing, by the computing device, instructions to pay the specified amount of cash in the first one of the plurality of offers; and
adding, by the computing device, the offer of the use of the second asset to the inventory.

10. The method of claim 9 wherein one of the first and second assets is a house, condominium, apartment or timeshare unit.

11. The method of claim 9 wherein one of the first and second assets is a boat or yacht.

12. The method of claim 9 wherein one of the first and second assets is an airplane.

13. A system for managing a pool of offers for the use of a plurality of assets comprising:
a memory for storing a database containing a plurality of offers, each offer being an offer from an owner of an asset in the plurality of assets of a use of the owner's asset in exchange for a specified amount of cash;
an input for receiving a purchase offer for a first one of the plurality of offers, the purchase offer containing an offer of a use of a second asset in the plurality of assets;
a processor configured to:
determine an equivalent cash value of the purchase offer;
compare the equivalent cash value of the purchase offer to the specified amount of cash in the first one of the plurality of offers;
if the equivalent cash value of the purchase offer is equal to or greater than the specified amount of cash in the first offer, settle the transaction by providing instructions to pay the specified amount of cash for the first one of the plurality of offers, and update the database by:
indicating that the first offer is no longer available; and
adding the second offer to the database.
